(19) United States
(12) Patent Application Publication
(10) Pub. No.: US 2014/0115680 A1
(43) Pub. Date: Apr. 24, 2014

(54) SERVER DEVICE

(71) Applicant: DeNA Co., Ltd., Tokyo (JP)

(72) Inventor: Toshiharu SUGIYAMA, Tokyo (JP)

(73) Assignee: DeNA Co., Ltd., Tokyo (JP)

(21) Appl. No.: 14/047,312

(22) Filed: Oct. 7, 2013

(30) Foreign Application Priority Data
Oct. 18, 2012 (JP) 2012-230423

(51) Int. Cl. H04L 29/06

(52) U.S. Cl. CPC H04L 63/08
USPC 726/7

(57) ABSTRACT

One object is to restrain unauthorized logins without significantly reducing usability. In accordance with one aspect, the server device according to an embodiment includes: an information storage unit for storing information; an information generating unit for generating login authentication information in response to a display request for a login screen sent from a terminal device; a sending unit for sending login screen data for displaying the login screen on the terminal device; a receiving unit for receiving login information from the terminal device; and a determination unit for determining whether a login is permitted based on the received login information. The login screen data includes an instruction for converting the login authentication information.

### CROSS-REFERENCE TO RELATED APPLICATIONS

This application is based on and claims the benefit of priority from Japanese Patent Application Serial No. 2012-230423 (filed on Oct. 18, 2012), the contents of which are hereby incorporated by reference in their entirety.

### TECHNICAL FIELD

The present invention pertains to a server device and particularly to a server device communicatively connected to a plurality of client terminals.

### BACKGROUND

Conventionally known server devices of this type include server devices for providing various services such as electronic commerce to users of client terminals connected to the server device via a network such as the Internet. A user can log in the server device with a user ID and a password to use various services. For example, electronic commerce frequently handles information confidential to users such as credit card information; therefore, it is required to prevent unauthorized login by a malicious third party. Such an unauthorized login is often performed with a program tool exclusively for unauthorized login. Methods proposed to prevent unauthorized logins include IP address restriction that restricts sequential login attempts from a same IP address, image authentication in which a user visually recognizes and inputs a character string included in an image displayed in a screen, and login with a temporarily available password issued by a one-time password generation device (see, for example, Japanese Patent Application Publication No. 2012-27530).

However, IP address restriction may be bypassed by randomizing the IP addresses by using a botnet; and excessive restriction may restrict logins by normal users. Additionally, the above-mentioned image authentication and authentication by the one-time password generation device reduce usability because these authentications require a user to visually recognize and input a character string included in an image or to carry a one-time password generation device.

### SUMMARY

One object of the restrain invention is to restrict unauthorized logins without significantly reducing usability. Other objects of the present invention will be clarified by reference to the entire description in this specification.

A server device according to an embodiment of the present invention is a server device communicatively connected to a plurality of client terminals, the server device comprising: a sending unit configured to send, in response to a request from one of the plurality of client terminals, login page information to the client terminal, the login page information used for rendering a login page on the client terminal and including a parameter value and an instruction for a process of converting the parameter value based on a predetermined rule; a receiving unit configured to receive, from the client terminal having received the login page information, a login request including at least the parameter value converted through the process in accordance with the instruction; and a determination unit configured to determine whether to permit a login by the client terminal based at least on the received parameter value.

A system according to an embodiment of the present invention comprises a first server device according to the above embodiment of the present invention and a second server device according to the above embodiment of the present invention, wherein the first server device employs a first rule as the predetermined rule, and the second server device employs a second rule as the predetermined rule, the second rule being different from the first rule.

A login determination method according to an embodiment of the present invention is a method of determining whether to permit a login by a client terminal, the method comprising the steps of: (a) sending, in response to a request from one of the plurality of client terminals, login page information to the client terminal, the login page information used for rendering a login page on the client terminal and including a parameter value and an instruction for a process of converting the parameter value based on a predetermined rule; (b) receiving, from the client terminal having received the login page information, a login request including at least the parameter value converted through the process in accordance with the instruction; and (c) determining whether to permit a login by the client terminal based at least on the received parameter value.

Various embodiments of the present invention restrain unauthorized logins without significantly reducing usability.

### BRIEF DESCRIPTION OF THE DRAWINGS

FIG. 1 is a block diagram schematically illustrating a network configuration of a system including a server device according to an embodiment of the present invention.

FIG. 2 is a block diagram schematically illustrating the architecture of a terminal device according to an embodiment.

FIG. 3 is a block diagram illustrating the functionality of the server device according to an embodiment.

FIG. 4 is a diagram showing an example of a token management table according to an embodiment.

FIG. 5 is a flow diagram showing a login process according to an embodiment.

FIG. 6 is a diagram showing an example of login screen data according to an embodiment.

FIG. 7 is a diagram showing an example of a login screen according to an embodiment.

### DESCRIPTION OF EXAMPLE EMBODIMENTS

Various embodiments of the present invention will be described hereinafter with reference to the drawings. In the drawings, the same components are denoted by the same reference numerals.

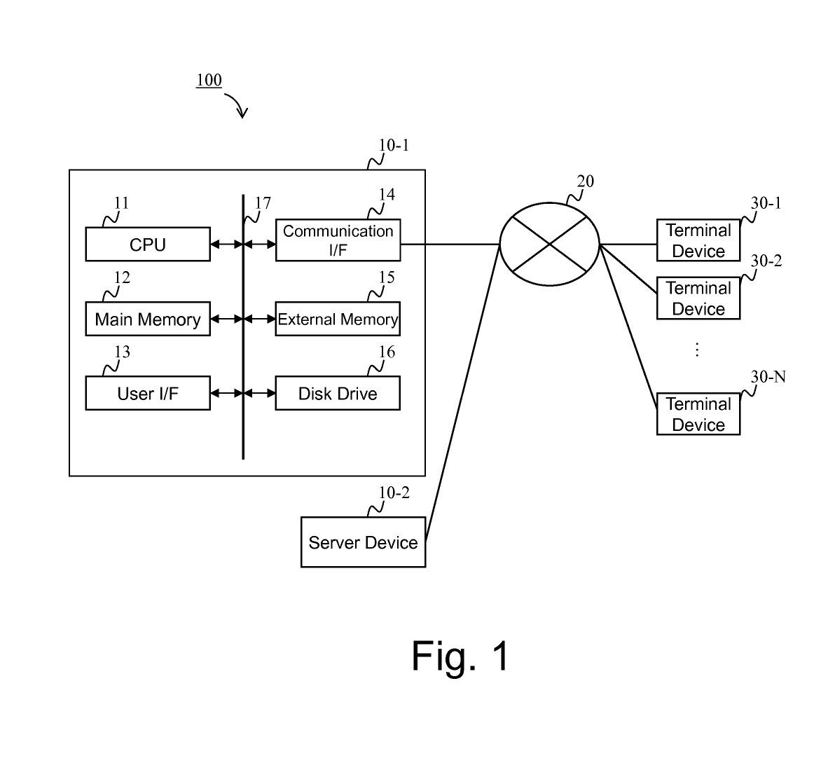

FIG. 1 is a block diagram schematically showing a system 100 according to an embodiment of the present invention including server devices 10-1, 10-2 (hereinafter collectively referred to as “server devices 10”) according to an embodiment of the present invention. As illustrated in FIG. 1, the system 100 according to an embodiment may be provided with the server devices 10-1, 10-2 and is communicatively connected to a plurality of terminal devices 30-1, 30-2, . . . , and 30-N (hereinafter also collectively referred to as the “terminal devices 30”), each having a communication function, via a communication network 20 such as the Internet.

As illustrated in FIG. 1, a server device 10 according to an embodiment may include a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and may store various programs. The external memory 15 may also store various data. The various data that may be stored in the external memory 15 may also be stored on a database server communicatively connected to the server device 10 and physically separate from the server device 10. The disk drive 16 may read data stored in a storage medium such as a compact disc read only memory (CD-ROM), digital versatile disc read only memory (DVD-ROM), or DVD Recordable (DVD-R) disc, or writes data to such a storage medium. For example, applications and data stored in a storage medium may be read by the disk drive 16, and may be installed into the external memory 15.

In an embodiment, the server device 10 may serve as a web server for communicating with the terminal devices 30 in HTTP to manage a web site including a plurality of hierarchical web pages and provide the terminal devices 30 with various services. The terminal devices 30 may fetch HTML data for rendering a web page from the server device 10 and analyze the HTML data to present the web page to a user of the terminal devices 30. The HTML data for rendering the web page may also be stored on the external memory 15. HTML data may comprise HTML documents written in markup languages such as HTML; the HTML documents may be associated with various images. Additionally, the HTML documents may include programs written in script languages such as ActionScript™ and JavaScript™.

The external memory 15 may store applications to be executed on execution environments of the terminal device 30 other than browser software. This application may include programs and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software delivered from the server device 10 may be received by the terminal device 30 through a communication I/F 34 in accordance with the control of CPU 31; the received programs may be sent to an external memory 35 and stored thereon. The application software may be launched in accordance with the player's operation on the terminal device 30 and may be executed on a platform implemented on the terminal device 30 such as NgCore™ or Android™.

Thus, the server device 10 may manage the web site for providing services and deliver web pages constituting the web site in response to a request from the terminal device 30. Also, the server device 10 can provide services based on communication with an application performed on the terminal device 30 in place of, or in addition to, such browser-based services. Whichever mode may be taken to provide the services, the server device 10 can store data required to provide the services for each identification identifying a user. Non-limiting examples of the services provided by the server device 10 include online games, social networking services (SNS), electronic commerce, and distribution of digital contents such as music, electronic books, or videos.

In an embodiment, the terminal device 30 may be a desired information processing device capable of rendering, on a web browser, web pages fetched from the server device 10; for example, the terminal device 30 may be a mobile phone, smart phone, game console, personal computer, touch pad, or electronic book reader, but is not limited thereto. The terminal device 30 may also be a desired information processing device including an application execution environment for executing an application.

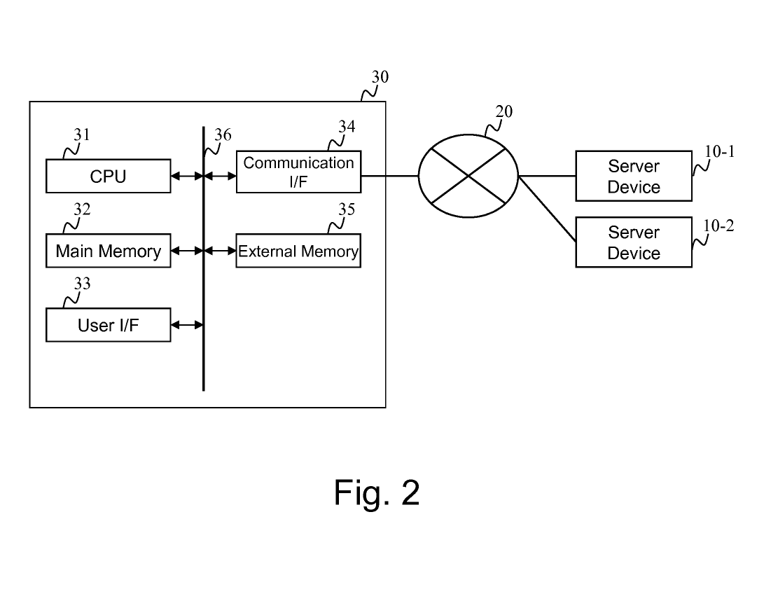

The architecture of the terminal device 30 will be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server devices 10 via the communication network 20.

The external memory 35 may comprise, for example, a magnetic disk drive or a flash memory and store various programs such as an operating system. When receiving an application from a server device 10 via the communication I/F 34, the external memory 35 may store the received application.

A terminal device 30 having such an architecture may include, for example, browser software for interpreting an HTML file (HTML data) and rendering a screen; this browser software may enable the terminal device 30 to interpret the HTML data fetched from the server device 10 and render web pages corresponding to the received HTML data. Further, the terminal device 30 may include plug-in software (e.g., Flash Player distributed by Adobe Systems Incorporated) embedded into browser software; therefore, the client device 30 can fetch from the server device 10 a SWF file embedded in HTML data and execute the SWF file by using the browser software and the plug-in software.

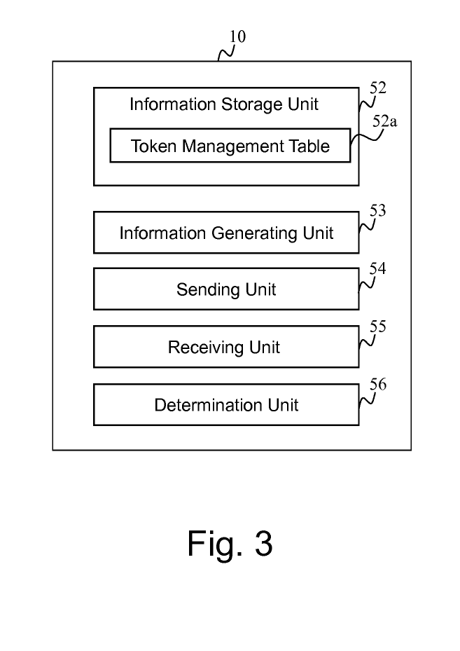

Next, the functionality of the server device 10 implemented by the components shown in FIG. 1 will now be described. FIG. 3 is a block diagram illustrating the functionality of a server device 10 according to an embodiment of the present invention. As shown in FIG. 3, the server device 10 according to the embodiment may comprise: an information storage unit 52 for storing information; an information generating unit 53 for generating login authentication information in response to a display request for a login screen sent from a terminal device 30; a sending unit 54 for sending login screen data for displaying the login screen on the terminal device 30; a receiving unit 55 for receiving login information from the terminal device 30; and a determination unit 56 for determining whether a login is permitted based on the received login information. These functions may be implemented through cooperation between the CPU 11 and programs, tables, and the like stored in the main memory 12 and the external memory 15. The above functions may be related to login determination implemented in a server device 10 according to an embodiment; and the server device 10 may also include other various functions for providing services.

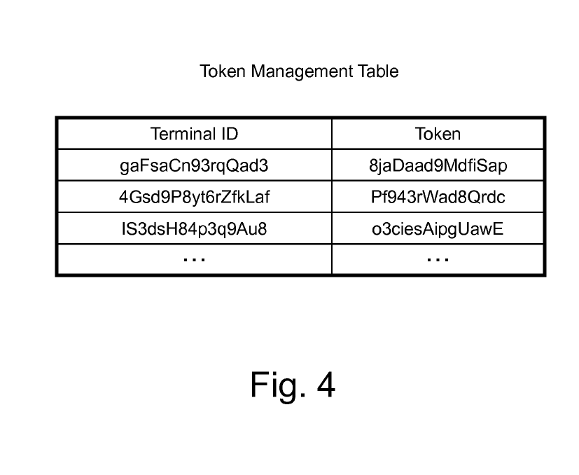

The information storage unit 52 may include a token management table 52a for managing tokens as information for login authentication. FIG. 4 illustrates an example of the token management table 52a. As shown in FIG. 4, the token management table 52a may store a token generated by the information generating unit 53 in association with the terminal ID identifying a terminal device 30. As in the examples shown in FIG. 4, both a terminal ID and a token are a character string containing a plurality of randomly arranged alphanumeric characters.

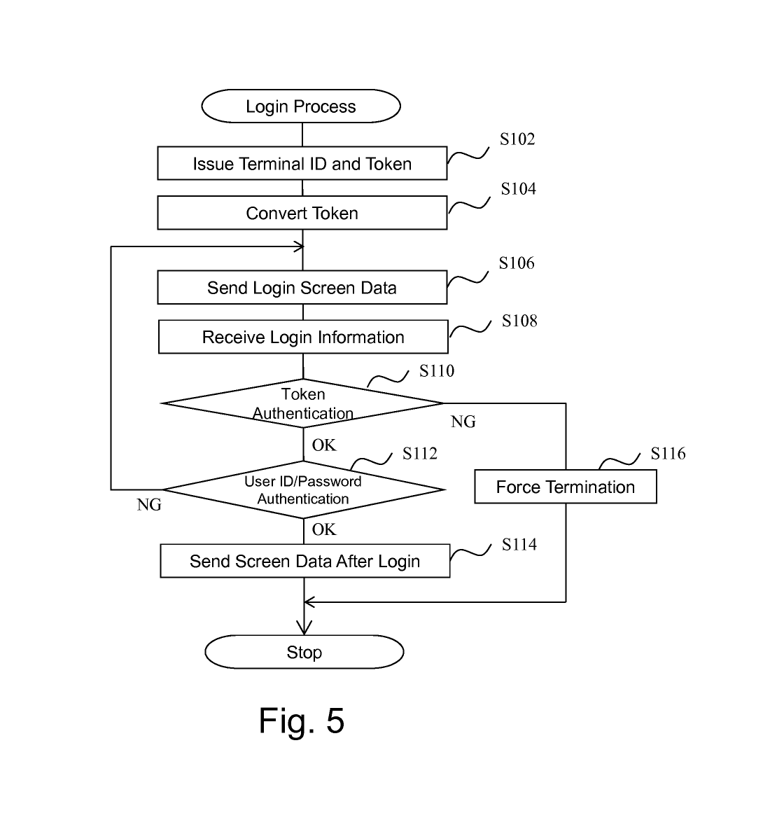

Next, operations of such a server device 10 as an embodiment of the present invention will now be described. FIG. 5 is a flow diagram showing an example of a login process performed by the server device 10. The login process may be performed in response to a display request for the login screen to the server device 10 received from the terminal device 30. More specifically, in an embodiment, the login process may be performed when the server device 10 receives an HTTP request designating the URL of the login screen to the services provided by the server device 10, from a web browser or an application on the terminal device 30. The first step of the login process is to issue a terminal ID for identifying a terminal device 30 that sent the display request for the login screen and a token as authentication information used for login authentication, and store both in the token management table 52a (step S102). As described above, the terminal ID and the token may be a character string containing a plurality of randomly arranged alphanumeric characters. These random character strings may be generated by using, for example, a common gateway interface (CGI) having implemented therein a random number generating algorithm. In an embodiment, a terminal ID may identify a terminal device 30 working as a client in HTTP and may be exchanged as cookie in the HTTP communication between the server device 10 and the terminal device 30. Further, in an embodiment, a terminal ID and a token may be generated by using different algorithms such that there is no relation between them. This is because any relation between them may possibly allow a malicious third party who knows one of them to perceive the other.

After a terminal ID and a token are issued, the value of the issued token are converted (step S104). In an embodiment, conversion of a value of a token may be performed by reversing the order of characters in the string. For example, a token “Pf943rWad8Qrdc” may be converted into “cdrQ8daWr349fP.” Such conversion by reversing the order of characters in a string may be performed by using a CGI having implemented therein a string operation function for reversing the order of characters in a string.

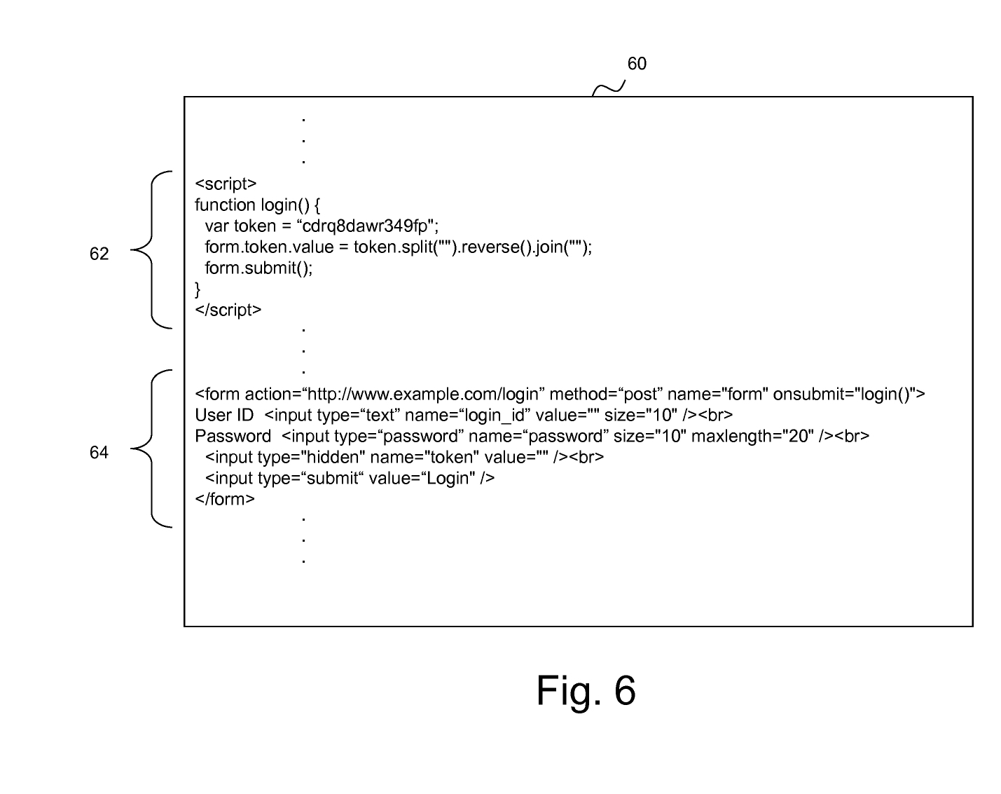

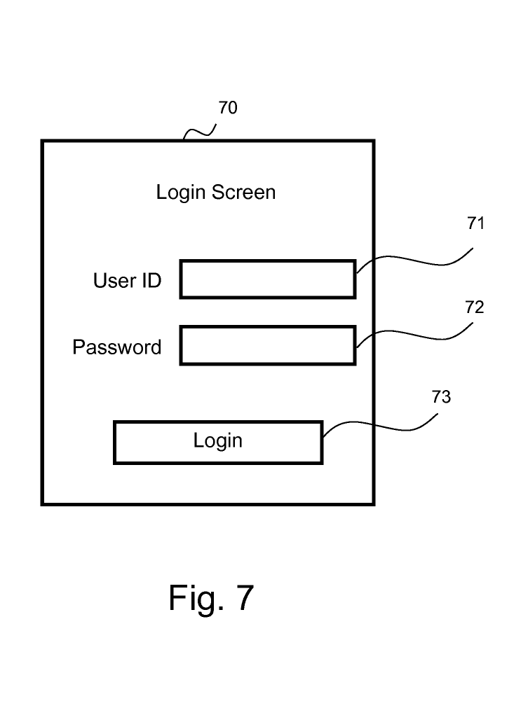

Subsequently, a login screen data having embedded therein a converted token may be sent to the terminal device 30 (step S106). FIG. 6 shows an example of a part of login screen data 60 sent from the server device 10 to the terminal device 30; and FIG. 7 shows an example of a login screen 70 displayed by a web browser, etc. on the terminal device 30 that has read the login screen data 60. As shown in FIG. 6, the login screen data 60 in this example may be formed of HTML data and include a script section 62 written in JavaScript™ and a form section 64 for defining input fields for user input. The converted token may be embedded in the script section 62 having a description “var token=‘cdrq8dawr349fp.’” The description “form.token.value=token.split(”).reverse( ).join(“);” in the script section 62 defines an instruction for converting the embedded token, and more specifically, in an embodiment, defines an instruction for a string operation of reversing the order of characters in the string of the token. That is, the order of the characters in the string of the token may be reversed in step S104; and the reversed order of the characters may be reversed again when the conversion process defined in the script section 62 is performed in the terminal device 30. As a result, the original token issued in step S102 may be restored. The form section 64 may define a user ID input field 71, a password input field 72, and a login button 73 in the login screen 70 shown in FIG. 7, and define the token as a hidden field that is not displayed in the login screen 70 in the description “<input type=‘hidden’ name=‘token’ value=”/>.” The token defined as a hidden field may not be displayed in the login screen 70 but may be sent to the server device 10 along with the values inputted in the user ID input field 71 and the password input field 72.

When the terminal device 30 receives the login screen data, a web browser or other functions of the terminal device 30 may analyze the login screen data to render the login screen 70. When a user of the terminal device 30 inputs a user ID and a password into the user ID input field 71 and the password input field 72 of the login screen 70, respectively, and presses the login button 73, the process for converting the token defined in the script section 62 of the login screen data 60 may be performed, and the converted token may be sent to the server device 10 along with the inputted user ID and password.

When the terminal device 30 sends the user ID, the password, and the converted token, the server device 10 may receive such information (step S108) and first perform authentication based on the value of the converted token received (step S110). More specifically, the server device 10 may retrieve a token corresponding to the terminal ID of the terminal device 30 from the token management table 52a and compare the retrieved token with the converted token received from the terminal device 30; if these tokens are identical, it is determined that the authentication is successful; and otherwise, it is determined that the authentication is unsuccessful. As described above, the token managed by the token management table 52a is the original token issued in step S102; meanwhile, the token sent from the terminal device 30 is tentatively converted by reversing the order of the characters in the string in step S104 and then again converted by reversing the order of the characters in the string by the terminal device 30 in accordance with the instruction for conversion defined in the script section 62 of the login screen data 60. Accordingly, if operations proceed as described above, the value of the token managed in the token management table 52a may be identical to the value of the token received from the terminal device 30, and it may be determined that the authentication is successful.

Suppose that a malicious third party attempts an unauthorized login to the server device 10. In general, the program tool exclusively for unauthorized login may analyze the method of sending, to the server device, login information such as a user ID and a password required for login, based on HTML data of a login screen such as the login screen 70 to the server device 10 according to an embodiment, thereby to enable sending of login information without complete reproduction of user operations (for example, login information may be sent without using a login screen). This may enable, for example, attempts to log in to a large number of web sites with a pair of user ID and password or attempts to log in to one web site with numerous sets of user IDs and passwords. As a result, an unauthorized login may be permitted when the combination of the attempted user ID and password is valid. A method of sending login information may be analyzed by performing a search with regular expressions on character strings such as tags constituting HTML data. As to the login screen data 60 for example, it may be determined that a hidden field “token” is included as necessary login information based on the description “<input type=‘hidden’ name=‘token’ value=”/>” in the form section 62; and it may be determined that the value of the hidden field “token” is “cdrq8dawr349fp” based on the description “var token=‘cdrq8dawr349fp’” in the script section 62. However, in the server device 10 according to an embodiment, the token embedded in the login screen data 60 is a character string in which the order of the characters is the reverse of that of the original token, and if such a token is sent to the server device 10, the token is not identical to the token managed in the token management table 52a (in the above example, the value of the token sent from the program tool is “cdrq8dawr349fp”; meanwhile, the value of the token managed by the token management table 52a is “Pf943rWad8Qrdc”). In this case, it may be determined that the authentication is unsuccessful, and the login process may be forcibly terminated (step S116).

When it is determined that the authentication is successful based on the value of the token, the authentication based on the user ID and the password may be performed subsequently (step S112). The authentication based on the user ID and the password may be performed by, for example, matching the user ID and the password with sets of user IDs and passwords stored in a table, etc. included in the information storage unit 52 and not shown in the figures, the sets of user IDs and passwords being previously inputted by users for user registration to services provided by the server device 10. Since such authentication based on user IDs and passwords are conventional, further detailed description is omitted. When, as a result of the authentication based on the user ID and password, it is determined that the authentication is unsuccessful, the processing may return to step S106, where the server device 10 may send the login screen data 60 again. When it is determined that the authentication is successful, the server device 10 may send screen data of a screen subsequent to the login (e.g., the top screen of a service to be provided) to the terminal device 30 (step S114) and ends the login process.

In the above login process, the string operation performed for conversion of the token in step S104 and conversion of the token by an instruction included in the login screen data 60 to be sent to the terminal device 30 in step S106 may be reversal of the order of the characters in the strings of the tokens. Meanwhile, server devices 10-1 and 10-2 in the system 100 according to an embodiment may perform the conversion of the tokens differently. For example, one of the server devices may convert a token through “the string operation of reversing the order of the characters in the string of the token” described above, while the other may convert a token through “the string operation of exchanging characters at predetermined positions (e.g., exchanging the second and fifth characters and exchanging the seventh and twentieth characters).” Thus, the server device 10-1 and the server device 10-2 may convert the tokens differently; therefore, even if the method of sending login information performed in the login screen to one of the server devices is known by analysis, an unauthorized login through the login screen to the other can be prevented. For example, suppose that one business operates the server device 10-1 and the server device 10-2 for providing different services. Even if an unauthorized login to one of the services becomes possible, an unauthorized login to the other can be prevented.

The server device 10 according to the embodiment of the present invention described above may issue, in response to a display request for the login screen to the server device 10 from a terminal device 30, a token to the terminal device 30, while converting the token by reversing the order of the characters in the string of the token; and then the server device 10 may send, to the terminal device 30, login screen data including the converted token and an instruction for again reversing the order of the characters in the string of the converted token, receive the token that has undergone the reversal of the order again as part of login information from the terminal device 30, and perform authentication based on the token. This may restrain unauthorized logins attempted by generally used program tools for unauthorized logins that analyzes login screen data by searching character strings included therein. Further, since a user of the terminal device 30 does not have to be conscious of this system of login determination, the usability may not be significantly reduced.

In the system 100 according to the embodiment of the present invention described above, the server device 10-1 and the server device 10-2 may convert the tokens differently; therefore, even if the method of sending login information performed in the login screen to one of the server devices is known by analysis, an unauthorized login through the login screen to the other can be prevented.

The server device 10 according to the embodiment may issue a token to a terminal device 30, while converting the token by reversing the order of the characters in the string of the token, and embed the converted token into login screen data. Alternatively, the server device 10 may also embed the token as issued into the login screen data without converting the issued token by reversing the order of the characters in the string. In this case, the terminal device 30 may send a token that is a reverse of the order of characters in the string of the original token; therefore, the server device 10 may compare the value of the received token with the value of the token that is a reverse of the order of characters in the string of the token as issued to perform the token-based authentication in step S110. In this mode, a token sent from a program tool for unauthorized logins, which is an as-issued token, can be detected in the token-based authentication; thus, an unauthorized login can be prevented.

The server device 10 according to the embodiment may convert a token by “the string operation of reversing the order of the characters in the string of the token” or “the string operation of exchanging characters at predetermined positions”; but the processing of converting a token is not limited to these string operations. Further, the server device 10 may not necessarily convert a token in the same way as the terminal device 30 converts a token in accordance with an instruction included in the login screen data. For example, suppose a string operation for converting a token wherein “the first character is moved to the third position, the third character is moved to the fifth position, and the fifth character is moved to the first position.” More specifically, suppose that the above string operation is performed on a character string “ABCDE.” This string operation may first result in “EBADC,” and then result in “CBEDA” when repeated one more time. The resultant string “CBEDA” is different from “ABCDE.” That is, when a token is converted in the server device 10 for the login process through a string operation wherein “the first character is moved to the third position, the third character is moved to the fifth position, and the fifth character is moved to the first position,” the login screen data have to include an instruction for conversion of a token through a string operation wherein “the third character is moved to the first position, the fifth character is moved to the third position, and the first character is moved to the fifth position.” Briefly, the server device 10 should convert the original token and embed the converted token into login screen data such that the original token can be restored through the conversion of the converted token by the instruction included in the login screen data. In other words, the conversion of a token by an instruction included in the login screen data should be reverse to the conversion of the original token performed in the server device 10.

The server device 10 according to the embodiment may form a token as a character string having a plurality of randomly arranged alphanumeric characters; alternatively, the token may not be a character string. For example, if a token is a numeric value, an appropriate mathematical operation, not a string operation, may also be applied to the conversion of the token.

The system 100 according to the embodiment may include the server device 10-1 and the server device 10-2; but naturally, the system 100 may include more than two server devices 10.

The processes and procedures described and illustrated herein may be implemented by software, hardware, or any combination thereof including those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A server device communicatively connected to a plurality of client terminals, the server device comprising:
an information generating unit configured to generate, in response to a request from one of the plurality of client terminals, authentication information for the client terminal and generate, based on the authentication information, pre-conversion authentication information to be converted into the authentication information through a conversion based on a predetermined rule;
a sending unit configured to send, to the client terminal, login page information for rendering a login page on the client terminal, the login page information including the pre-conversion authentication information as a parameter value and an instruction for a process of converting the parameter value based on the predetermined rule;
a receiving unit configured to receive, from the client terminal having received the login page information, a login request including at least the parameter value converted through the process in accordance with the instruction; and
a determination unit configured to determine whether to permit a login by the client terminal based at least on comparison of the received parameter value and the authentication information.

2. The server device of claim 1, wherein the parameter value is a character string, and the predetermined rule is related to a string operation.

3. A system comprising a first server device according to claim 1 and a second server device according to claim 1, wherein the first server device employs a first rule as the predetermined rule, and the second server device employs a second rule as the predetermined rule, the second rule being different from the first rule.

4. A method of determining whether to permit a login by a client terminal, the method comprising the steps of:
(a) generating, in response to a request from the client terminal, authentication information for the client terminal and generating, based on the authentication information, pre-conversion authentication information to be converted into the authentication information through a conversion based on a predetermined rule;
(b) sending, to the client terminal, login page information for rendering a login page on the client terminal, the login page information including the pre-conversion authentication information as a parameter value and an instruction for a process of converting the parameter value based on the predetermined rule;
(c) receiving, from the client terminal having received the login page information, a login request including at least the parameter value converted through the process in accordance with the instruction; and
(d) determining whether to permit a login by the client terminal based at least on comparison of the received parameter value and the authentication information.
